(19) United States
(12) Patent Application Publication
(10) Pub. No.: US 2010/0114700 A1
(43) Pub. Date: May 6, 2010

(54) System and method for synchronizing delivery of messages in multiple communications channels

(75) Inventor: Charles R. Chamberlain, Delaplane, VA (US)

Correspondence Address: ANDREWS KURTH LLP, 1350 I STREET, N.W., SUITE 1100, WASHINGTON, DC, 20005, US

(73) Assignee: Northrop Grumman Information Technology, Inc.

(21) Appl. No.: 12/588,971

(22) Filed: Nov. 4, 2009

Related U.S. Application Data
(60) Provisional application No. 61/193,193, filed on Nov. 4, 2008.

(51) Int. Cl. G06Q 30/00; G06F 17/00; G06Q 10/00; G06Q 50/00

(52) U.S. Cl. 705/14.52; 235/375; 705/14.58; 705/14.61; 705/14.69; 705/14.72; 705/14.73; 705/404; 705/408; 705/410

(57) ABSTRACT

A system and method synchronize delivery of messages in multiple communications channels by generating mailing information regarding a first message to be delivered through a first communications channel to a customer. The mailing information includes an identifier of the first message and is embedded into an intelligent mail barcode. The first message is then tracked using the mailing information by scanning the intelligent mail barcode to obtain tracking information. Based on the tracking information, the system and method coordinate delivery of a second message the content of which is related to the first message through a second communications channel to a group of people including the customer. Delivery of the first message through the first communications channel and delivery of the second message through the second communications channel is synchronized.

### BACKGROUND

When a mailer sends a piece of marketing campaign mail to a group of customers, the mailer may want to send a reinforcing message, such as a phone call, a broadcast message, or a video advertisement to, at or in a post office, office, home, computer, PDA or supermarket in the same locale of the group of customers. However, the mailer has to estimate the arrival of the piece of marketing campaign mail before sending the reinforcing message.

Under current procedures, a mailer can send a piece of mail with samples to indicate when the piece of mail was delivered. However, this practice provides only partial information, is costly, and does not provide real-time data to control real-time events. The use of a “confirm” code on a piece of mail enables the electronic collection of information. However, the “confirm” code has not been used to trigger activities in other media channels.

### SUMMARY

An embodiment of a method for synchronizing delivery of messages in multiple communications channels includes generating mailing information regarding a first message to be delivered through a first communications channel to a customer. The mailing information includes an identifier of the first message and is embedded into an intelligent mail barcode, RFID tag or other computer recognizable form. The method further includes tracking the first message using the mailing information by scanning the intelligent mail barcode to obtain tracking information. Based on the tracking information, the method includes coordinating delivery of a second message the content of which is related to the first message through a second/additional communications channel to a group of people including the customer. Delivery of the first message through the first communications channel and delivery of the second message through the second communications channel is synchronized.

An embodiment of a system for synchronizing delivery of messages in multiple communications channels includes a barcode generating module for generating mailing information regarding a first message to be delivered through a first communications channel to a customer. The mailing information includes an identifier of the first message and is incorporated into an intelligent mail barcode. The system further includes a tracking module for tracking the first message using the mailing information by scanning the intelligent mail barcode to obtain tracking information and a coordinating module for coordinating delivery of a second message through a second communications channel to a group of people including the customer based on the tracking information. The content of the second message is related to the first message. Delivery of the first message through the first communications channel and delivery of the second message through the second communications channel is synchronized.

A computer readable medium provides instructions for synchronizing delivery of messages in multiple communications channels. The instructions include generating mailing information regarding a first message to be delivered through a first communications channel to a customer. The mailing information includes an identifier of the first message and is embedded into an intelligent mail barcode. The instructions further include tracking the first message using the mailing information by scanning the intelligent mail barcode to obtain tracking information. Based on the tracking information, the instructions include coordinating delivery of a second message the content of which is related to the first message through a second communications channel to a group of people including the customer. Delivery of the first message through the first communications channel and delivery of the second message through the second communications channel is synchronized.

### BRIEF DESCRIPTION OF THE DRAWINGS

Exemplary embodiments of the system and method for synchronizing delivery of messages in multiple communications channels will be described in detail with reference to the following figures, in which like numerals refer to like elements, and wherein:

FIG. 1 is a block diagram illustrating an exemplary system for synchronizing delivery of messages in multiple communications channels;

FIG. 2 is a flow chart illustrating an exemplary method for synchronizing delivery of messages in multiple communications channels; and

FIG. 3 illustrates exemplary hardware components of a computer that may be used in connection with the method for synchronizing delivery of messages in multiple communications channels.

### DETAILED DESCRIPTION

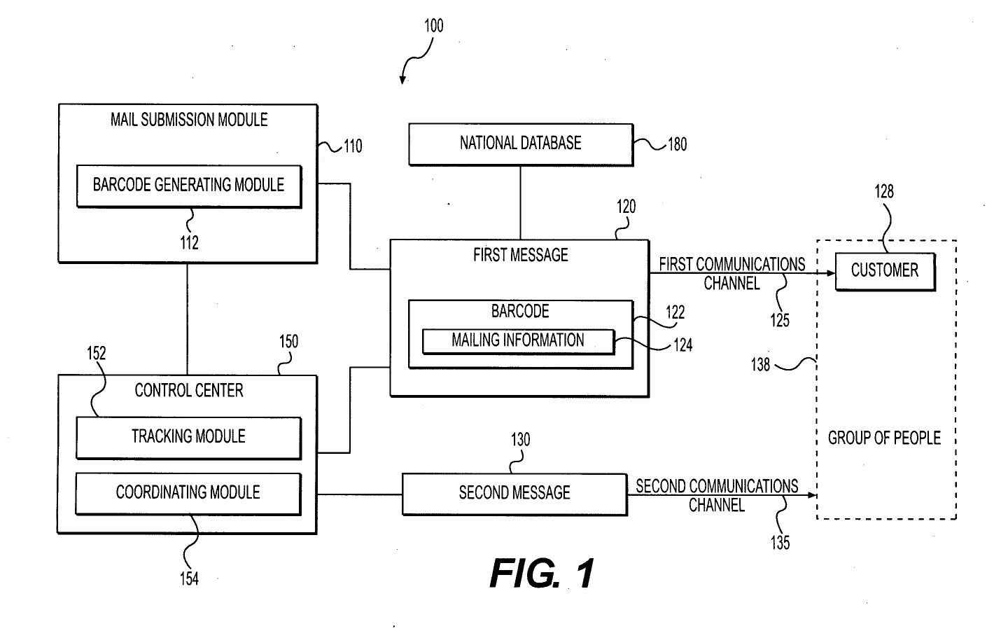

FIG. 1 is a block diagram illustrating an exemplary system 100 for synchronizing delivery of messages in multiple communications channels. The system 100 may include a mail submission module 110, which includes a barcode generating module 112, such as an intelligent mail barcode generating module, for generating mailing information 124 regarding a first message 120 delivered through a first communications channel 125 to a customer 128. The first message 120 may be, for example, a piece of United States (U.S.) mail containing a marketing campaign message, and the first communications channel 125 may be the U.S. mail service. The marketing campaign message is typically prepared by a marketing provider. The mailing information 124 may include an identifier, content information, origin information, and destination information of the first message 120. The identifier may be a piece of mail identifier for identifying the first message 120, such as the piece of U.S. mail containing a marketing campaign message. The content information may provide a short abstract of the first message 120. The origin information and destination information may provide the origination city and zip code and the destination city and zip code of the first message 120. The mailing information 124 may be incorporated into a barcode 122, such as an intelligent mail barcode.

The system 100 further includes a tracking module 152 located, for example, in a control center 150, for tracking the first message 120 using the mailing information 124 by scanning the barcode 122 to obtain tracking information. The tracking module 152 typically tracks the first message 120 by performing an origin scanning, a destination scanning, and necessary interim scanning. For example, using the identifier and the locality information of a scanner that scans the barcode 122, such as the intelligent mail barcode, the tracking module 152 may identify the actual location of the first message 120. Similarly, the tracking module 152 may determine that the first message 120 is approaching the destination using the destination information and the actual location of the first message 120. The tracking information may be real-time data providing, for example, the date and time of arrival of the first message 120.

The system 100 further includes a coordinating module 154 for coordinating delivery of a second message 130 through a second communications channel 135, i.e., additional communications channel, to a group of people 138 including the customer 128 based on the tracking information. The coordinating module 154 may also be located, for example, in the control center 150.

The second message 130 is typically generated by the marketing provider based on the content information of the first message 120 and is therefore related to the first message 120. Using the content information and destination information of the first message 120, and other statistics, the coordinating module 154 can coordinate the corresponding second message 130 to be delivered around the same time as the delivery of the first message 120 so that the messages reinforce each other. For example, the coordinating module 154 may release the second message 130 within 24 hours of an anticipated delivery of the first message 120. As a result, the delivery of the first message 120 through the first communications channel 125 and the delivery of the second message 130 through the second communications channel 135 is synchronized.

The second message 130 may be, for example, an online marketing campaign message that is prepared by the marketing provider to reinforce the first marketing campaign message sent by, for example, the U.S. mail. The second communications channel 135 may be the Internet. The second message 130 may also be an audio marketing campaign message, and the second communications channel 135 may be a radio broadcast channel. Likewise, the second message 130 may be a video marketing campaign message, and the second communications channel 135 may be a television broadcast channel. Similarly, the second message 130 may be a video marketing campaign message that is displayed on a screen. The video marketing campaign message may remind the group of people 138 to look for the first message 120 to be delivered through the first communications channel 125. Finally, the second message 130 may be a telephone call to the customer reminding the customer to look for the first message 120 to be delivered through the first communications channel 125. As a result, the second message 130 reinforces the first message 120 once the first message 120 arrives. The types of messages are described for illustration purposes. One skilled in the art will appreciate that other types of messages can equally be applied.

The group of people 138 may be located in a same zip code area as the customer 128. For example, the second message 130 may be displayed in a post office or a supermarket in the city and zip code where the customer 128 is located so that the second message 130 will likely be viewed by the customer 128. The second communications channel 135 may optionally be selected depending on the customer's 128 income level, educational level, hobbies, and other preferences. For example, if the customer 128 is in the higher income group, the second communications channel 135 may be a video marketing campaign message that is displayed on a screen in a premium grocery store or an upscale department store.

The second communications channel 135 is typically a faster channel than the first communications channel 125. The system 100 uses the intelligence of the slower communications channel, i.e., the first communications channel 125, to drive the faster communications channel, i.e., the second communications channel 135, to synchronize delivery through these two channels.

The system 100 may further include a national database 180 that includes all of the advertisement mail (i.e., first messages 120) to be delivered through the first communications channel 125. The system 100 may post contents of the national database 180 on the Internet so that the customer 128 can view, at his or her leisure, one or more pieces of advertisement mail (i.e., first message 120) upon receiving a reinforcing message (i.e., second message 130) reminding him or her of the existence and delivery of one or more pieces of advertisement mail. This is particularly useful when a customer has a habit of throwing away advertisement mail but becomes interested in one piece of mail (i.e., first message 120) after receiving a reinforcing message (i.e., second message 130) associated with the piece of mail. The customer 128 can logon to search for this piece of mail in the national database 180.

The system 100 typically allows the first message 120 to be submitted into the first communications channel 125 with a payment. Regarding the reinforcing message, the system 100 may provide a marketing provider an option of two or more second messages 130 to be delivered through different communications channels 135. Each of the second messages 130 may be associated with a different price.

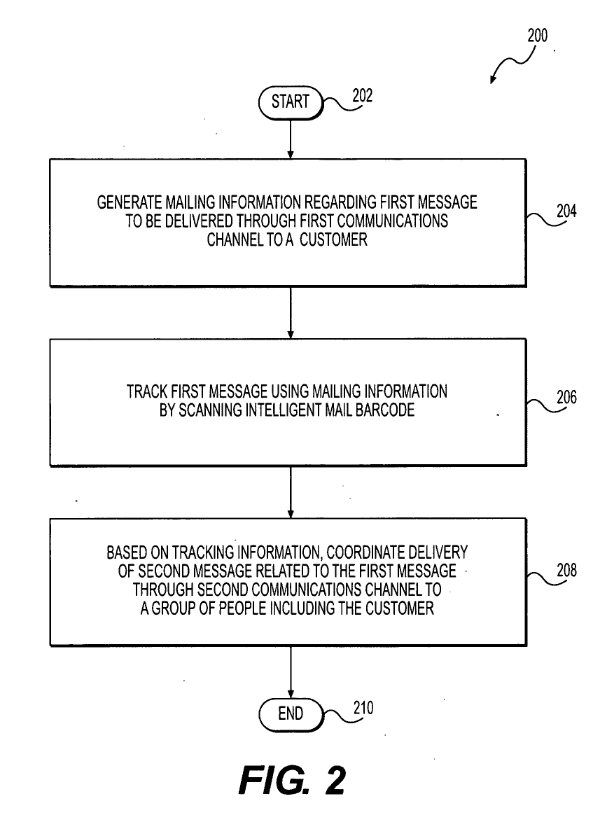

FIG. 2 is a flow chart illustrating an exemplary method 200 for synchronizing delivery of messages in multiple communications channels. The exemplary method 200 starts 202 by generating mailing information regarding a first message delivered through a first communications channel to a customer (block 204). The mailing information includes an identifier, origin information, and destination information of the first message. The mailing information is incorporated into an intelligent mail barcode. The method 200 next tracks the first message using the mailing information by scanning the intelligent mail barcode to obtain tracking information (block 206). Next, based on the tracking information, the method 200 coordinates delivery of a second message through a second communications channel to a group of people including the customer (block 208). The content of the second message is related to the first message. As a result, delivery of the first message through the first communications channel and delivery of the second message through the second communications channel is synchronized. The method 200 ends at 210.

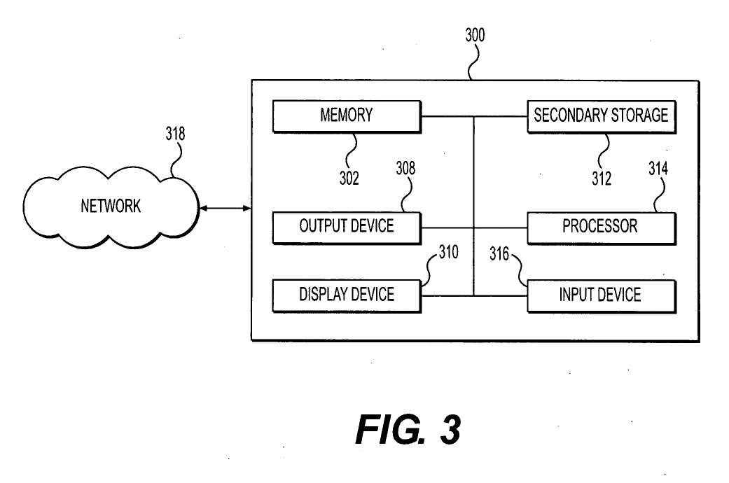

FIG. 3 illustrates exemplary hardware components of a computer 300 that may be used in connection with the method for synchronizing delivery of messages in multiple communications channels. The computer 300 includes a connection 320 with a network 318 such as the Internet or other type of computer or telephone network. The computer 300 typically includes a memory 302, a secondary storage device 312, a processor 314, an input device 316, a display device 310, and an output device 308.

The memory 302 may include random access memory (RAM) or similar types of memory. The secondary storage device 312 may include a hard disk drive, floppy disk drive, CD-ROM drive, or other types of non-volatile data storage, and may correspond with various databases or other resources. The processor 314 may execute information stored in the memory 302, the secondary storage 312, or received from the Internet or other network 318. The input device 316 may include any device for entering data into the computer 300, such as a keyboard, keypad, cursor-control device, touch-screen (possibly with a stylus), or microphone. The display device 310 may include any type of device for presenting a visual image, such as, for example, a computer monitor, flat-screen display, or display panel. The output device 308 may include any type of device for presenting data in hard copy format, such as a printer, or other types of output devices including speakers or any device for providing data in audio form. The computer 300 can possibly include multiple input devices, output devices, and display devices.

Although the computer 300 is shown with various components, one skilled in the art will appreciate that the computer 300 can contain additional or different components. In addition, although aspects of an implementation consistent with the method for synchronizing delivery of messages in multiple communications channels are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM or remotely across a communications channel. The computer-readable media may include instructions for controlling the computer 300 to perform a particular method.

While the system and method for synchronizing delivery of messages in multiple communications channels have been described in connection with an exemplary embodiment, those skilled in the art will understand that many modifications in light of these teachings are possible, and this application is intended to cover variations thereof.

What is claimed is:

1. A method for synchronizing delivery of messages in multiple communications channels, comprising:
generating mailing information regarding a first message to be delivered through a first communications channel to a customer, the mailing information including an identifier of the first message, wherein the mailing information is embedded into an intelligent mail barcode;
tracking the first message using the mailing information by scanning the intelligent mail barcode to obtain tracking information; and
based on the tracking information, coordinating delivery of a second message the content of which is related to the first message through a second communications channel to a group of people including the customer,
wherein delivery of the first message through the first communications channel and delivery of the second message through the second communications channel is synchronized.

2. The method of claim 1, wherein the first message is a piece of United States mail containing a marketing campaign message, and wherein the first communications channel is the United States mail service.

3. The method of claim 2, wherein the second message is an online marketing campaign message, and wherein the second communications channel is the Internet.

4. The method of claim 2, wherein the second message is an audio marketing campaign message, and wherein the second communications channel is a radio broadcast channel.

5. The method of claim 2, wherein the second message is a video marketing campaign message, and therein the second communications channel is a television broadcast channel.

6. The method of claim 2, wherein the second message is a video marketing campaign message that is displayed on a screen.

7. The method of claim 6, wherein the video marketing campaign message reminds the group of people to look for the first message to be delivered through the first communications channel and wherein the second message reinforces the first message once the first message arrives.

8. The method of claim 1, wherein the second message is a telephone call to the customer reminding the customer to look for the first message to be delivered through the first communications channel and wherein the second message reinforces the first message once the first message arrives.

9. The method of claim 1, wherein the group of people is located in a same zip code area as the customer.

10. The method of claim 1, wherein the second communications channel is a faster channel than the first communications channel.

11. The method of claim 1, wherein the tracking step includes identifying a location of the first message using the identifier and locality information obtained from a scanner that scans the intelligent mail barcode.

12. The method of claim 1, further comprising generating the second message based on the content information of the first message.

13. The method of claim 1, further comprising:
creating a national database of the first message delivered through the first communications channel; and
posting contents of the national database on the Internet so that the customer can view the first message upon receiving the second message.

14. The method of claim 1, further comprising compiling statistics regarding the first message using the destination information, wherein the statistics include a date and time of arrival of the first message, and wherein the coordinating step uses the statistics to synchronize delivery of the first message and the second message.

15. The method of claim 1, further comprising:
allowing the first message to be submitted into the first communications channel with a payment; and
providing a marketing campaign provider an option of two or more second messages to be delivered through different communications channels, each of the second messages being associated with a different price.

16. The method of claim 1, wherein the tracking step includes performing one or more of an origin scanning, a destination scanning, and an interim scanning.

17. The method of claim 1, wherein the second message is delivered within 24 hours of an anticipated delivery of the first message.

18. The method of claim 1, wherein the mailing information includes one or more of content information, origin information, and destination information.

19. A system for synchronizing delivery of messages in multiple communications channels, comprising:
a barcode generating module for generating mailing information regarding a first message to be delivered through a first communications channel to a customer, the mailing information including an identifier of the first message, wherein the mailing information is incorporated into an intelligent mail barcode;
a tracking module for tracking the first message using the mailing information by scanning the intelligent mail barcode to obtain tracking information; and
a coordinating module for coordinating delivery of a second message through a second communications channel to a group of people including the customer based on the tracking information, the content of the second message being related to the first message,
wherein delivery of the first message through the first communications channel and delivery of the second message through the second communications channel is synchronized.

20. The system of claim 19, wherein the coordinating module is located in a control center.

21. The system of claim 20, wherein the tracking module is located in the control center.

22. The system of claim 19, wherein the tracking module identifies a location of the first message using the identifier and locality information obtained from a scanner that scans the intelligent mail barcode.

23. The system of claim 19, further comprising:
a national database that stores the first message delivered through the first communications channel, wherein contents of the national database are posted on the Internet so that the customer can view the first message upon receiving the second message.

24. The system of claim 19, wherein the coordinating module compiles statistics regarding the first message using the destination information, wherein the statistics include a date and time of arrival of the first message, and wherein the coordinating module uses the statistics to synchronize delivery of the first message and the second message.

25. A computer readable medium providing instructions for synchronizing delivery of messages in multiple communications channels, the instructions comprising:
generating mailing information regarding a first message to be delivered through a first communications channel to a customer, the mailing information including an identifier of the first message, wherein the mailing information is embedded into an intelligent mail barcode;
tracking the first message using the mailing information by scanning the intelligent mail barcode to obtain tracking information; and
based on the tracking information, coordinating delivery of a second message the content of which is related to the first message through a second communications channel to a group of people including the customer,
wherein delivery of the first message through the first communications channel and delivery of the second message through the second communications channel is synchronized.
